(19) United States
(12) Patent Application Publication
(10) Pub. No.: US 2006/0166709 A1
(43) Pub. Date: Jul. 27, 2006

(54) Battery powered devices

(76) Inventor: Linda Leech, REIGATE (GB)

Correspondence Address: PHILIPS INTELLECTUAL PROPERTY & STANDARDS, P.O. BOX 3001, BRIARCLIFF MANOR, NY, 10510, US

(21) Appl. No.: 10/564,918

(22) PCT Filed: Jul. 12, 2004
(86) PCT No.: PCT/IB04/02356

§ 371 Date: Jan. 17, 2006

(30) Foreign Application Priority Data
Jul. 19, 2003 (GB) 0316969.5

(51) Int. Cl. H04B 1/16; H04B 1/38

(52) U.S. Cl. 455/574; 455/343.1

(57) ABSTRACT

A method for managing the power consumption of a battery powered radio device, the method comprising performing (104) a radio function according to a first operating mode; monitoring (106) the battery capacity; and, where the battery capacity is less than a pre-determined amount, maintaining (112) the radio function according to a second operating mode in place of the first operating mode, which second operating mode has a reduced rate of power consumption in relation to the radio function compared to the first operating mode.

The present invention relates to managing the power consumption of a battery powered device, in particular a radio device.

In recent years there have been introduced a wide range of battery powered devices many of which wirelessly connect to other devices or systems by means of radio, for example cordless and mobile telephones. An objective for designers is to maximise the time of operation of such products when run on a set of exchangeable batteries or on a single charge of a rechargeable battery. Nevertheless, for any battery powered device there occurs the situation in which the battery is nearly exhausted, but access to a replacement set of batteries or to recharging is not possible at that moment in time.

In Japanese Patent Application 2001-202337 a radio terminal including a wireless circuit section and a data processing circuit section is disclosed that can effectively utilise functions of the data processing circuit section even when the capacity of a battery is decreased. A disadvantage of the method disclosed is that a control circuit compares the residual capacity of the battery with a threshold and interrupts the supply of power to the radio circuit section while maintaining supply of power to the data processing circuit section when the residual capacity of the battery is lower than the threshold.

It is an object of the present invention to improve on the known art.

In accordance with the present invention there is provided a method for managing the power consumption of a battery powered radio device, the method comprising:
performing a radio function according to a first operating mode;
monitoring the battery capacity; and
where the battery capacity is less than a pre-determined amount, maintaining the radio function according to a second operating mode in place of the first operating mode, which second operating mode has a reduced rate of power consumption in relation to the radio function compared to the first operating mode.

The radio function of the device is maintained as the battery capacity reduces. Advantageously the invention enables the device to continue to function for longer for a given battery capacity compared to devices in the art while also being implementable at low incremental cost.

Advantageously, the second operating mode of the battery powered radio device comprises receiving a radio signal by means of polling. Alternatively, the second operating mode comprises sending a request radio signal and subsequently receiving an associated response radio signal. Preferably the radio signals comprise data messages. Ideally, the battery powered radio device is managed using a set of different operating modes, a mode of the set being selected according to the prevailing battery capacity. The set may comprise more than two operating modes each selectable according to different pre-determined prevailing battery capacities. In this case selection in turn of the appropriate mode may further extend the time of operation of the radio function. Optionally, other functions of the battery powered radio device can be shut down at some pre-determined battery capacities to further conserve battery power.

Clearly, another radio device communicates by means of radio signals with the battery powered radio device. Preferably the other device is mains powered; examples of suitable other devices are those which comprise a radio transmitter such as a telephone basestation or a consumer entertainment product (TV, audio system or the like).

The present invention is a result of the realisation that timely use of power management techniques can be used to extend the duration of use of a radio function beyond that obtainable in the prior art, whilst maintaining functionality. In a first example, the invention enables extended duration of operation of the radio function associated with determining the location of a (mislaid) battery powered radio device such as a cordless telephone handset or suitably equipped consumer product remote control unit. In a second example, the invention enables extended duration of operation of the radio function associated with receipt of data by a suitably equipped battery powered radio device such as receiving an SMS message on a mobile telephone.

Embodiments of the invention will now be described, by way of example only, with reference to the accompanying drawings in which:

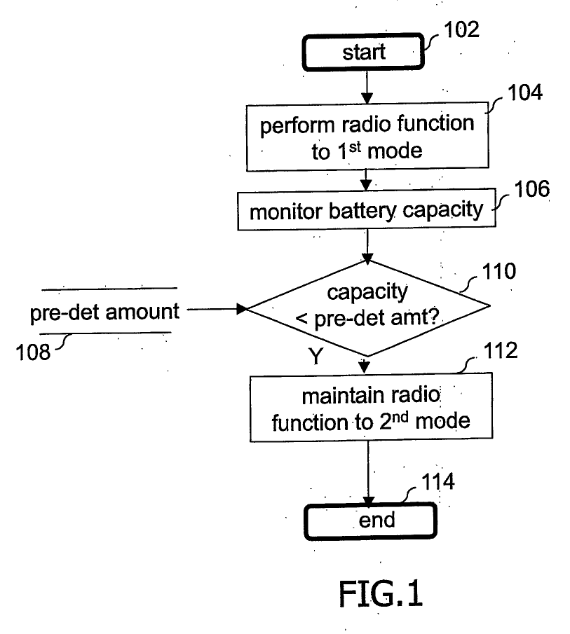

FIG. 1 is a flow diagram of a method for managing the power consumption of a battery powered radio device;

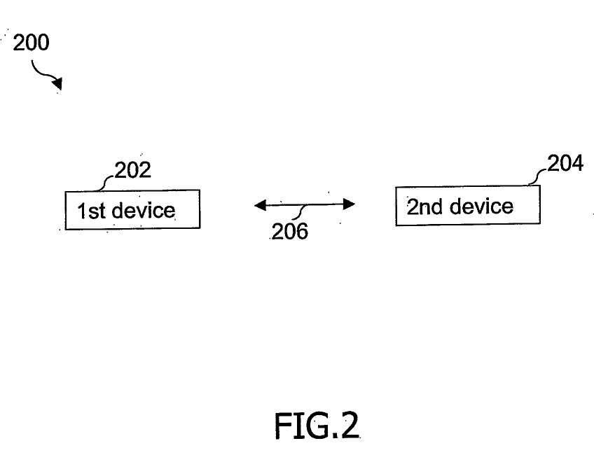

FIG. 2 is a schematic representation of a system comprising a battery powered radio device managed according to the method of FIG. 1; and

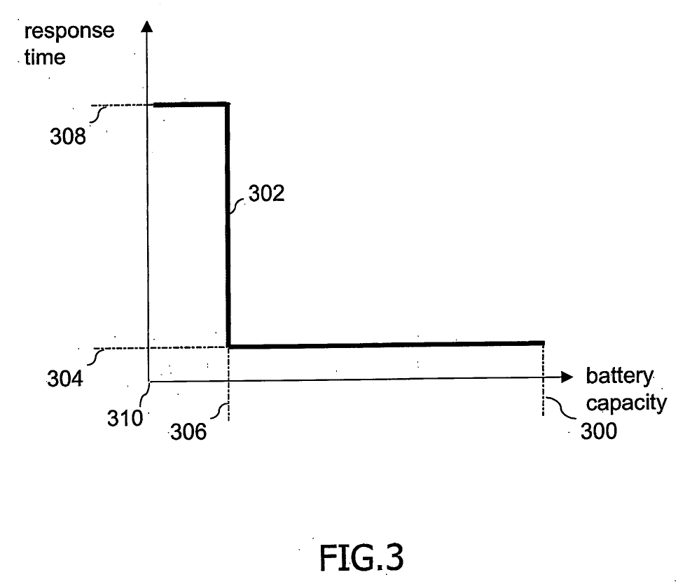

FIG. 3 is a schematic representation of the response time of a feature of a battery powered radio device when the device is managed using a set of operating modes according to the method of FIG. 1.

FIG. 1 shows a flow diagram of a method for managing the power consumption of a battery powered radio device. The method starts at 102 and performs 104 a radio function of the device according to a first operating mode. One example of a first operating mode is normal operation of a radio function of the device. In the case of a cordless or mobile telephone this may be the standby feature wherein the radio receiver within the telephone monitors for the occurrence of an incoming signal (for example representing a call or message) or other form of prompt, such as in the case of a cordless telephone, a paging signal from the basestation used for locating a mislaid handset. Similarly, for a remote control handset suitably equipped with a location function, the radio receiver within the handset monitors for the occurrence of a paging signal from a suitably equipped source such as TV.

While performing the radio function according to the first operating mode, the battery capacity of the device is monitored 106. Suitable methods for monitoring battery capacity are known in the art. Indeed, some products such as mobile telephones include such capability thereby facilitating deployment of a method according to the present invention. When the battery capacity is determined 110 to be less than a pre-determined amount 108, the radio function is maintained 112 according to a second operating mode. It is to be noted that the radio function is maintained. This means that the radio function is still active, the second operating mode having a reduced rate of power consumption of the battery in relation to the radio function compared to the first operating mode. Typically, the response time of a feature of the device served by the radio function is increased when operating according to the second operating mode compared to the first operating mode.

Preferably, performing the radio function according to the second operating mode comprises receiving a radio signal by means of polling; in this context, a suitable example of polling comprises occasionally and briefly enabling the radio receiver of the handset to receive a relevant radio signal. The use of such a polling technique is particularly advantageous in the present invention in that it allows a set of rates of power consumption of the battery to be implemented, each being selected according to the prevailing battery capacity. Furthermore, polling is suitable for radio devices which only have unidirectional radio communication with another radio device.

Alternatively, performing the radio function according to the second operating mode comprises sending a request radio signal and subsequently receiving an associated response radio signal. This method is suitable for systems which have bi-directional radio communication

Consider a first example of a cordless telephone in which the handset is presently running on its internal battery (for example, not docked with a battery charger) and is presently in standby mode monitoring for an incoming call or a paging signal (sent by the cordless phone basestation to help locate a mislaid handset). At some point in time, the battery capacity will be determined to be less than a pre-determined amount. At this point in time, the radio function associated with determining the location of the handset is maintained according to a second operating mode which in this example involves the radio receiver polling for the occurrence of the relevant paging signal from the cordless phone basestation. The rate of polling employed by the handset will have a direct effect on the rate of power consumption of the residual battery capacity: the more infrequent the polling, the longer the battery will power the radio function, but also the longer will be the response time of the location feature. An example rate of polling might be say once every 10 seconds which would enable the battery to power the function for perhaps a correspondingly longer period than would be the case using the first operating mode.

The pre-determined amount might be preset at manufacture or be determined by the user. One example of a suitable pre-determined amount might be one made according to telephone talk-time: for example, the amount might represent a few minutes of talk time which it is deemed is not especially useful in practice and could better be used to extend the duration of operational time of the handset locating feature.

The above example of a cordless telephone location function also applies to a suitably equipped remote control handset operating in conjunction with a suitably equipped consumer electronics product such as a TV.

Consider a second example of a GSM mobile telephone in which the telephone handset is presently running on its internal battery (that is, not docked with a battery charger) and is presently in standby mode monitoring for an incoming call or an SMS message (sent by a GSM basestation). At some point in time, the battery capacity will be determined to be less than a pre-determined amount. At this point in time, the radio function associated with the receipt of data (in this case, receipt of data related to the SMS message service) is maintained according to a second operating mode. The radio function could operate by means of polling as previously described; however, in this example it involves the mobile telephone handset sending (transmitting) a request radio signal to the GSM basestation and subsequently receiving an associated response radio signal from the GSM basestation, for example an SMS message or acknowledgement message (for example when there is no SMS message to send to the mobile telephone handset). The number of request/response events per time period initiated by the mobile telephone handset will have a direct effect on the rate of power consumption of the residual battery capacity: the more infrequent each request/response event, the longer the battery will power the radio function, but also the longer will be the corresponding delay between receipt of an incoming SMS message at the GSM basestation and receipt of that message at the mobile telephone handset. An example rate of request/response events might be say one event every few minutes which would enable the battery (for a given capacity) to power the radio function for a considerably longer period (for example 10 times longer) than would be the case according to a normal operating mode for SMS messages. This example also supports the sending of an SMS message as part of the request radio signal; this may entail a corresponding additional power consumption for each sent message. In conclusion, using the techniques described above the useful feature comprising the reception and/or sending of an SMS message can be maintained for an extended duration of operation when the battery is nearly exhausted. Moreover, for some battery powered radio devices a suitable method can be implemented at low incremental cost by means of a software adaptation within the device; for example, within a cordless or mobile telephone which already comprises battery capacity monitoring. The method of FIG. 1 ends at 114.

FIG. 2 is a schematic representation of a system comprising a battery powered radio device managed according to the method of FIG. 1. The system, shown generally at 200, comprises a first radio device 202 which is battery powered and a second radio device 204, the devices being operable to communicate by means of radio signals 206. The first device, as managed according to the method of FIG. 1, is operable to receive radio signals from the second device by means of polling or by request/response events, as described earlier in relation to FIG. 1. It is to be noted that the second device is compatible with the operating modes employed by the first device. To illustrate this aspect, where the radio function of the first device is utilising polling the second device transmits signals which are suitable for reception by means of such polling, for example by transmitting the signals for a sufficient duration of time so as to span the time interval of polling by the first device. An example is where polling occurs periodically once each 10 seconds, the second device transmits a suitable radio signal over at least substantially the same time period. Suitable radio signals which also satisfy applicable regulatory requirements are readily identifiable to the skilled person.

FIG. 3 shows a schematic representation of the response time of a feature of a battery powered radio device when the device is managed using a set of operating modes according to the method of FIG. 1. The Figure shows battery capacity along the abscissa and response time of the feature along the ordinate; the feature being served by a radio function of the device. An example of a feature is the handset locating feature of a cordless telephone. The response time curve 302 is shown for battery capacity values ranging from full 300 to empty 310. During use between full capacity 300 and capacity 306, the radio function of the device operates according to a first operating mode thereby providing a response time 304 for the feature served by the radio function. Typically, the radio function is arranged so as to provide optimal response time for the function during this range of capacity (that is, the range between 300 and 306). An example is a cordless telephone handset locating feature which essentially works (responds) in a time period close to real-time; that is, a user may invoke the locate handset feature on the basestation and the handset then quickly responds, substantially in real-time. Below battery capacity 306, the radio function of the device operates according to a second operating mode thereby providing a response time 308 for the feature served by the radio function. This response time may be appreciably longer than that enabled by the first operating mode; this can be due to the second operating mode accessing the radio channel less often than in the first operating mode. By restricting use of the radio channel the rate of battery power consumption is reduced. For a feature such as handset location, the rate of consumption can be substantially proportional to the rate of accessing of the radio channel—reducing access by 10 fold compared to the first operating mode can yield a similar increase in duration of operation of the feature from the remaining battery capacity, albeit with also a substantially similar increase in response time. However, in practice, the response time for such an example represents a short user wait of a matter of seconds which is a small penalty in return for the extended availability of the function for locating a misplaced handset. Clearly, for a particular application feature a suitable response time can be chosen. The above example also applies to the location feature of a suitably equipped remote control handset in radio communication with a corresponding basestation device which may be incorporated within a TV set or similar consumer apparatus.

Considering an example of a GSM mobile phone, battery capacity 306 could represent the capacity at which practically very little talk time is left, for example representing just a few minutes. In this case it may be decided that when the battery capacity is less than 306 the radio function of the mobile telephone is operated according to a second operating mode which enables text messages to be exchanged or received by sending a request radio signal to the GSM basestation and subsequently receiving an associated response radio signal (e.g. an SMS message addressed to the mobile telephone terminal). This request/response event could be initiated by the mobile telephone for example on a periodic basis; additionally or alternatively, the initiation can be on demand, for example when the user wishes to send an SMS message.

Battery capacity can be provided by any suitable means including one or more physical battery packs, which packs may utilise any preferred or practical combination of dry and rechargeable battery types. A particular implementation may utilise a single battery and monitor its capacity to determine the 306 capacity. Another implementation might utilise separate physical batteries, each providing capacities 300-306 and 306-310 respectively.

The foregoing method and implementation are presented by way of example only and represent a selection of a range of methods and implementations that can readily be identified by a person skilled in the art to exploit the advantages of the present invention.

In the description above and with reference to FIG. 1 there is disclosed a method for managing the power consumption of a battery powered radio device, the method comprising performing 104 a radio function according to a first operating mode; monitoring 106 the battery capacity; and, where the battery capacity is less than a pre-determined amount, maintaining 112 the radio function according to a second operating mode in place of the first operating mode, which second operating mode has a reduced rate of power consumption in relation to the radio function compared to the first operating mode.

1. A method for managing the power consumption of a battery powered radio device, the method comprising:
performing (104) a radio function according to a first operating mode;
monitoring (106) the battery capacity; and
where the battery capacity is less than a pre-determined amount, maintaining (112) the radio function according to a second operating mode in place of the first operating mode, which second operating mode has a reduced rate of power consumption in relation to the radio function compared to the first operating mode.

2. A method as claimed in claim 1, wherein the second operating mode comprises receiving a radio signal by means of polling.

3. A method as claimed in claim 1, wherein the second operating mode comprises sending a request radio signal and subsequently receiving an associated response radio signal.

4. A system comprising a first radio device which is battery powered and is operable according to claim 1 and a second radio device, the devices being operable to communicate by means of radio signals.

5. A battery powered radio device operable according to the method of claim 2, wherein the radio function is associated with determining the location of the device.

6. A battery powered radio device according to claim 5, wherein the battery powered radio device is a cordless telephone.

7. A battery powered radio device according to claim 5, wherein the battery powered radio device is a remote control handset.

8. A battery powered radio device operating according to claim 2, wherein the radio function is associated with receipt of data.

9. A battery powered radio device according to claim 8, wherein the battery powered radio device is a mobile telephone.

10. A battery powered radio device according to claim 9, wherein the mobile telephone is a GSM telephone operable to receive an SMS message.

11. A record carrier comprising software operable to carry out the method of claim 1.

12. A software utility configured for carrying out the method steps as claimed in claim 1.

13. A battery powered radio device including a data processor, said data processor being directed in its operations by a software utility as claimed in claim 12.
